(19) United States
(12) Patent Application Publication
(10) Pub. No.: US 2020/0301643 A1
(43) Pub. Date: Sep. 24, 2020

(54) MULTI-DEVICE DOCUMENT VIEWER

(71) Applicant: Mark Griffiths, Manhattan Beach, CA (US)

(72) Inventor: Mark Griffiths, Manhattan Beach, CA (US)

(21) Appl. No.: 16/821,570

(22) Filed: Mar. 17, 2020

Related U.S. Application Data
(60) Provisional application No. 62/820,709, filed on Mar. 19, 2019.

(51) Int. Cl. G06F 3/14; G06F 3/033; G06F 3/01; G06F 21/33; G06F 40/103

(52) U.S. Cl. CPC G06F 3/1446; G06F 3/0334; G06F 40/103; G06F 21/33; G06F 3/011

(57) ABSTRACT

A method of operating a multi-device document viewer includes receiving a selection of two or more computing devices to be included in a selected group of computing devices that create the multi-device document viewer; assigning the two or more computing devices to the selected group; assigning a page offset value for each of the two or more computing devices in the selected group, the page offset value identifying an offset from a base page for each of the two or more computing devices; receiving a selection of a document to be viewed on the multi-device document viewer at one computing device of the two or more computing devices; and displaying pages of the selected document on the two or more computing devices corresponding based on the assigned page offset value for each of the two or more computing devices.

### RELATED APPLICATIONS

This application claims priority to U.S. provisional patent application Ser. No. 62/820,709, filed Mar. 19, 2019, entitled “MULTIPLE-DEVICE DOCUMENT VIEWER,” the disclosure of which is hereby incorporated by reference.

### BACKGROUND

A concert pianist sometimes has trouble turning the pages of sheet music while simultaneously playing the piano with both hands. If the page turn has not been done fast enough, or it accidentally flicks back to the previous page, it can throw off the performance and introduce anxiety to the performer. Solutions exist for performers. There are existing methods for performers to turn sheet music on a tablet.

A first method is a conventional single tablet, full page reader app in portrait orientation. This solution provides the performer with a quick tap or swipe to move to the next page. However, the performer can only see half as much music per page-turn than reading a conventional book of sheet music so this is not a feasible solution.

A second method includes the use of an extra foot pedal that moves forward the page of sheet music on a single tablet. This solution has the advantage of turning the page without interrupting either hand, but it requires the performer to learn to co-ordinate page turning with a foot. In addition, the performer still only see half as much music per page-turn than reading a conventional book of sheet music. Additionally, the need for extra hardware is an added complication.

A third solution is a conventional single tablet, two-page reader in landscape orientation. This third solution combines a quick tap or swipe to move pages combined with being able to see two pages of music akin to reading a conventional book of sheet music. However, the notes are so small, the performer cannot see them on a device with typical display size. Thus, all of the existing solutions all have limitations and a better solution is necessary.

### SUMMARY

In some implementations, a method of operating a multi-device document viewer includes receiving a selection of two or more computing devices to be included in a selected group of computing devices that create the multi-device document viewer; assigning the two or more computing devices to the selected group; assigning a page offset value for each of the two or more computing devices in the selected group, the page offset value identifying an offset from a base page for each of the two or more computing devices; receiving a selection of a document to be viewed on the multi-device document viewer at one computing device of the two or more computing devices; and displaying pages of the selected document on the two or more computing devices corresponding based on the assigned page offset value for each of the two or more computing device.

In some implementations, the method of operating the multi-device document viewer further includes receiving a password for the selected group of computing devices; and allowing access to the selected group of computing devices if the password matches the group password. In some implementations, the selection of a document is received at a master computing device, and the master computing device communicate the selected document to remaining computing devices of the computing devices that are not the master computing device.

In some implementations, the selection of the document is not received at a master computing device, and the other computing device communicates a message to the master computing device identifying which document is selected and communicating the selected document to remaining computing devices of the selected group of computing devices besides the master computing device. In some implementations, the master computing device communicates the selected document to the remaining computing devices.

In some implementations, the method includes receiving a page change selection from one of the one or more computing devices to change pages that are to be displayed on the two or more computing devices and also includes communicating a message to other computing devices of the one or more computing devices besides the one computing device that received the page change selection identifying that the page change selection has been received. In some implementations, the method includes loading a page of the selected document corresponding to the base page plus the page offset value for each of the associated computing devices.

In some implementations, the method may include receiving a change page offset request from an individual computing device and communicating the change page offset request to other computing devices besides the individual computing device. In some implementations, the method may alternatively include receiving a change base page request from an individual computing device and communicating the change base page request to other computing devices besides the individual computing device.

In some implementations, the method may further include receiving a leave group message from one computing device; communicating the leave group message to the other computing devices in the group; and removing the one computing device from group of computing devices that formed the multi-device document viewer. In some implementations, a remote computing device may control operations of the group of computing devices that form the multi-device document viewer. In some implementations, the method may further include receiving a brightness value change request at one computing device of the group of computing devices; communicating the brightness value change request to other computing devices in the group of computing devices besides the one computing device; and changing a brightness level in displays or monitors of the group of computing device in response to the brightness value change request.

In some implementation, a foot pedal is communicatively coupled with one or more computing devices of the group of computing devices, and the foot pedal communicates a page turning request to the group of computing devices to cause the group of computing devices to simultaneously change the displayed pages in each of the group of computing devices. In some implementations, two or more accelerometers are present, at least one accelerometer is assigned to each respective computing device, the two or more accelerometers to capture acceleration measurements of each of the two or more computing devices in the group of computing devices, and to determine positions of the two or more computing devices relative to each other based at least in part on the captured acceleration measurements. In some implementations, the method may include aligning the two or more computing devices together in a stack, pressing a button on the top computing device, and then moving the two or more computing devices into a final position for display. In some implementations, the method may further include calculating the page offsets from the different acclerations readings or measurements received from the one or more accelerometers subsequent to pressing the button on the top computing device.

In some implementations, the method for operating a multi-device document viewer may include receiving an indicator or messages that a page offset button or icon at a first computing device has been pressed for longer than a predetermined time; and entering an easy page offset mode at the first computing device. In some implementations, the method for operating a multi-device document viewer may further include communicating to all other computing devices of the two or more computing devices in the group that an easy page offset mode has been initiated. In some implementations, the method for operating a multi-device document viewer may further include tapping each of the computing devices in an order that corresponds to the page offset for the page offset for each of the computing devices and setting the page offset value according to the tapping order.

### INCORPORATION BY REFERENCE

All patents, applications, and publications referred to and identified herein are hereby incorporated by reference in their entirety, and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates three computing devices or mobile computing devices in a group of computing devices in a multi-device document viewer according to some implementations;

FIG. 2 illustrates three computing devices operating the page turning software application according to some implementations;

FIG. 3 illustrates a sequence of events when a page is turned in a page turning software application according to some implementations;

FIG. 4 shows a small or remote computing device (e.g., a smartphone or mobile communication device) communicating with and controlling the page turning software application remotely according to some implementations;

FIG. 5 illustrates communications between a computing device (e.g., an initiating computing device) and the rest of computing devices of the group of the multi-device document viewer utilizing a multicast message according to some implementations; and

FIG. 6 illustrates a process flow diagram of the page-turning software application according to some implementations.

### DETAILED DESCRIPTION

The motivation for the claimed subject matter was to alleviate the problems identified in the background application. In some implementations, by simply having two or three (or more) tablets/computing devices) sitting side-by-side, with each tablet/computing device displaying a full page of sheet music relative to their position, the performer may simply tap or swipe left or right on any one of the devices, and the pages for all devices move to their respective next or previous page in unison. In addition to allowing performers to more easily move between pages during musical performances, the disclosure herein may also be utilized in different applications.

There are other applications of this claimed subject matter besides the display of sheet music. In some implementations, for example, there are other applications such as the presentation of slide shows, Microsoft Powerpoint presentations or other presentations on computer screens where it is important to have multiple screens in use at the same time to allow a user or operator or viewer to follow the flow. Accordingly, citing the claimed subject matter's use for displaying sheet music does not limit the scope of the present patent application to just the displaying and turning of sheet music for performers.

In some implementations, the disclosure presented herein is sufficient to enable one of ordinary skill in the art to practice the described subject matter, and provides a best mode of practicing the described subject matter presently contemplated by the inventor (and also different methods and/or systems for practicing the described subject matter). While there is provided herein a full and complete disclosure of the preferred configurations of this described subject matter, it is not desired to limit the claimed subject matter to the exact construction, dimensional relationships, and operation shown and described. Various modifications, alternative constructions, changes and equivalents will readily occur to those skilled in the art and may be employed, as suitable, without departing from the true spirit and scope of the described subject matter. Such changes might involve alternative materials, alternative components, alternative structural arrangements, sizes, shapes, forms, functions, operational features or the like.

The described subject matter has been described herein using specific embodiments for the purposes of illustration only. It will be readily apparent to one of ordinary skill in the art, however, that the principles of the described subject matter can be embodied in other ways. Therefore, the described subject matter should not be regarded as being limited in scope to the specific embodiments disclosed herein, but instead as being fully commensurate in scope with the following subject matter.

References throughout this specification to one implementation, an implementation, some implementations, one embodiment, embodiments, an embodiment and/or the like means that a particular feature, structure, and/or characteristic described in connection with a particular implementation and/or embodiment is included in at least one implementation and/or embodiment of described subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope and scope of the described subject matter, for example. In general, of course, these and other issues vary with context. Therefore, particular context of description and/or usage provides helpful guidance regarding inferences to be drawn.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and described subject matter is not limited to these one or more illustrative examples; however, again, particular context of description and/or usage provides helpful guidance regarding inferences to be drawn.

In some implementations, the terms or phrases “portable computing device, mobile computing device and/or mobile communications device may be used interchangeably herein to refer to a computing device that is portable that includes processing capability and/or communications capability (e.g., both cellular and data communications). In some implementations, these computing devices may include network computing devices, smartphones, cellular phones with data capability, tablets, laptop computing devices and/or wearable computing devices that can be utilized with the page turning software application. In some implementations, computing devices may refer to other more stationary computing devices such as desktop computing devices, server computing devices, and/or cloud-based computing devices. In some implementations, microprocessors, controllers, microcontrollers, and/or processors may be also be utilized interchangeably herein.

In some implementations, the claimed subject matter may be referred to as a multiple-device document viewer. In some implementations, the multiple-device document viewer may include a software application executing on more than one computing devices (e.g., computer-readable instructions stored in one or more memory devices on multiple computing devices and executable by one or more processors on the computing devices). In some implementations, the software application that runs or is executable on several computing devices that together act as one single device (or perform operations in concert and/or coordination with each other.

In some implementations, the computing devices used with the claimed subject matter (e.g., the multiple-device document viewer) that are supported may be an: (a) Apple iPad running IOS operating system or other tablet computing device running Google's Android operating system; (b) Apple iPhone or iPod Touch mobile communications device running IOS operating system; (c) A smartphone or mobile communication device running Google's Android operating system; (d) a smart TV connected to an Apple TV unit, or a similar smart device running or executing Google's Android operating system; and/or (e) For input only, an Apple Watch or similar computing device wearable, or similar device running Google's Android operating system. These are just illustrative computing devices that may be utilized with the described subject matter. Other computing devices having large monitors or display screens may also be utilized with the described subject matter.

In some implementations, the computing or communication devices should have the capability to communicate with each other and can communicate via any wireless or wired communications protocols or devices available. The wireless or wired communications protocols or devices include, but are not limited to: (a)—Bluetooth (or other personal area network wireless communication protocols); (b) WiFi (or other wireless LAN or 802.11 communication protocols); (c) Cellular communication protocols, including but not limited to 3G, 4G and 5G cellular communication protocols; and/or (d) Wired ethernet communication protocols (via a lightning to ethernet adapter for Apple iOS or USB to ethernet adapter for Android devices).

In some implementations, the computing devices executing the page-turning software application, may utilize local communication protocols or devices (Bluetooth, PAN, WiFi or wireless LAN) to communicate page-turning instructions and/or parameters between the computing devices in the multi-device document viewer. In some implementations, internet or global communications network or connectivity may not be required for the page turning operation, but the Internet or global communications network capability may be useful for loading entire document content (e.g., the sheet music for the complete music piece or other documents) onto at least one of the computing devices.

In some implementations, the page-turning software application may be some downloaded from a remote server or computing device (or even another local computing device) and may be installed in one or more memory devices located within each computing device that will be utilized by the performer or user. In some implementations, the page-turning software application (e.g., the computer-readable instructions) may be executable by one or more processors on the more than one computing devices. Please note that the page-turning software application may be computer-readable instructions that are stored in one or more memory devices of a computing device and that may be executable by one or more processors of a computing device to initiate the page-turning software.

In some implementations, when the page-turning software application first launches, the user may be presented with two options. In some implementations, with a first option, the user or operator may start a group session for a number of computing devices. In some implementations, a user or operator may create a group name (or may select from a list of group names saved from the past). Optionally, in some implementations, a password can be associated with the group and a user or operator may need to input a password in order to be allowed into or access the group. In some implementations, the group session may be associated with a library of readable content stored on or associated with the more than one computing devices. In some implementations, a computing device may start to advertise to the group of computing device by broadcasting the new group name (or established group name) to its peers (e.g., peer computing devices that a performer or user may utilize) in the group via one or more communication protocols described above. In some implementations, the computing device advertising the group may be considered the “master” for the group (or a master computing device).

In some implementations, a user or operator may join an existing group session. In some implementations, this may be adding a computing device to an existing group session. In some implementations, the new computing device may search its communications domain (e.g., utilizing Bluetooth transceivers, WiFi transceivers, other PAN transceivers, or wireless LAN transceivers) for other computing devices that have started a group session. In some implementations, a window may pop up with a list of names of other nearby computing devices that the new computing device has detected that are also running the page-turning software app and have also chosen to start a group session. In some implementations, if the selected group session has a password associated with it, the user or operator may be required to enter the correct password to join the group/group session. In some implementations, the computing device joining the existing group may be considered a “slave” computing device for the group. In some implementations, upon the successful joining to the group of a group computing device, the master computing device may send or communicate a list of content (e.g. media content or other content) to the joined slave computing device(s) that the master computing device has as joining and/or forming the group of computing devices that become the multi-device document viewer. In some implementations, note at this point, the master computing device may not send any of the actual content itself to the slave computing devices. In some implementations, however, the master computing device may communicate the actual content itself to the one or more slave computing devices.

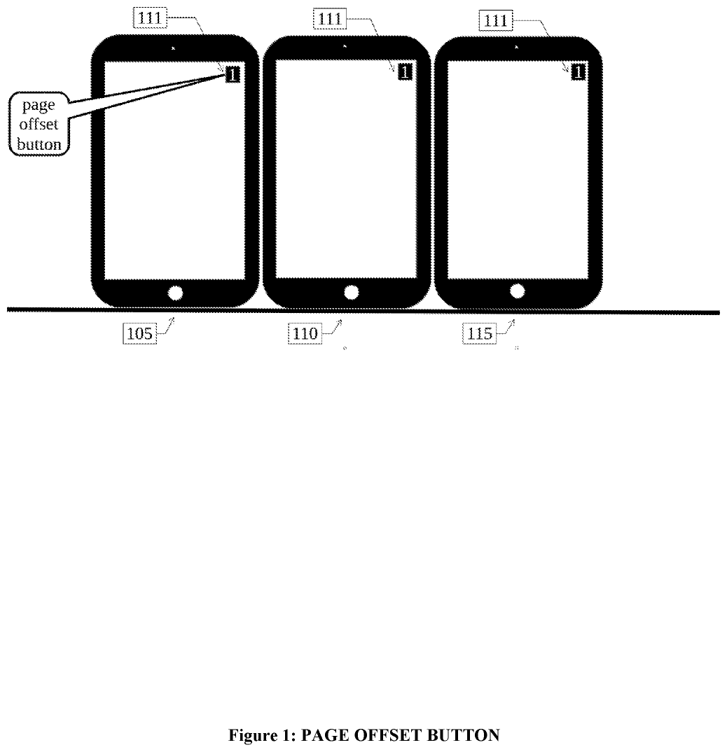

In some implementations, the computing device placement in the multi-device document viewer may be important to the claimed subject matter in order to provide seamless page turning or page turning that does not interfere with a performer or user's performance. In other words, the placement of the computing devices must be easily viewable to the performer or user in addition to allow the performer to have minimal distraction. In some implementations, the computing devices in the group of computing devices that form the multi-device document viewer may be physically placed next to each other, thus making it look like the appearance of pages in a book, as is depicted in FIG. 1. FIG. 1 illustrates three computing devices or mobile computing devices 105 110 and 115 in a multi-device document viewer according to some implementations. In some implementations, the page turning software application may cause the mobile computing device screen or display to include a page offset button 111, which is a new or novel feature of the described subject matter.

In some implementations, each computing device or mobile computing device may have a “page offset” property, a page offset icon or a page offset button 111 that may be utilized to display and/or set the page offset. In some implementations, the “page offset” property may define where the computing device sits relative with respect to other computing devices with respect to or in regards to the page ordering (e.g., this may be a physical location with respect to other computing devices). In some implementations, initially, the page offset of all computing devices in a same group may be set to 1 (as is shown in FIG. 1).

In some implementations, the user or operator may be required to set up the computing devices in physical order (e.g., from left to right) by assigning page offsets for each computing device according to each computing device's physical position relative to the other computing devices in the group that forms the multi-device document viewer. In implementations, the user or operator may select the page offset ordering in one of 2 ways.

In a first way or method, in some implementations, a user or operator may tap the “page offset” button on the top right corner of the screen, as is shown in FIG. 1. In some implementations, the screen or display on a mobile computing device or computing device may be a touchscreen to allow a finger and/or stylus to select and/or increment the “page offset” button or icon. In some implementations, each tap may increment the page offset of the associated computing device to a maximum offset permissible. In some implementations, a maximum offset possible may represent a maximum number of pages that may be displayed at a time (which may also be a maximum number of computing devices being utilized in the group of computing devices that form or comprise the multi-device document viewer). In some implementations, typically a range of offset values may be 1 through 4, however the claimed subject matter is not limited in range of offset values. In some implementations, if the page offset is at the maximum offset (e.g., such as 4), then a new tap on the top right corner of the screen may be set the page offset back to 1.

In a second way or method, in some embodiments, on any of the computing devices or mobile computing devices, the user or operator may press the “page offset” button on the top right corner of the screen for 2 or more seconds (or another predetermined or preset time), and the computing device, which has the page offset button pushed, may signal and/or communicate to all other computing devices in the group that the computing device is in “easy page offset set” mode. In some implementations, in response to the communication from the originating computing device or mobile computing device, at this point, all of the computing device's page offset buttons (or the remaining computing devices in the group) may start flashing, and the user or operator may simply tap a main screen area of each computing device in an order of their page offsets. In some implementations, when the last computing device has been tapped, all computing devices may return to normal operation with the designated page offset which was just established utilizing the tapping process.

FIG. 1 illustrates that the computing devices are positioned so that the screens may display any content in portrait mode. Thus, in FIG. 1, the computing devices are positioned vertically (which may correspond to a portrait mode). In some implementations, the computing devices may display content in a landscape mode and may be physically positioned to display in landscape mode (e.g., the computing devices may be rotated clockwise or counterclockwise 90 degrees). In these implementations, the computing devices or mobile computing devices may also be positioned horizontally and/or diagonally.

Selecting Readable Content—In some implementations, to start a viewing session in the page-turning software application, the user or operator may open or select an item from a list of content from any of the computing devices or mobile computing devices by pressing or selecting a button on a computer screen or input screen of the page-turning software application. In some implementations, if the computing device from which the selection is made is the master computing device, the master computing device may initiate a download of a selected content file or files (that is stored in one or more memory devices of the master computing device) to all of the slave computing devices within the established group of computing devices that form the multi-device document viewer. In some implementations, if the computing device from which the selection is made is a slave device, the selected slave computing device may send a message to the master computing device to initiate a download of the content file that the master computing device may have stored locally to all of the slave computing devices for downloading into the slave computing device's memory (or to all of the other slave computing devices if the initiating slave computing device already has the selected content file).

In some implementations, after receiving the selected content file, the slave computing device(s) may communicate or send messages to the master computing device and to the other remaining computing devices in the group to confirm receipt of the content file from the master computing device. In some implementations, the content file or files may include one or more documents, and the one or more documents may include a plurality of pages (e.g., such as 3 or more pages and up to 1000 pages, although the described subject matter is not limited to such a number of pages). In some implementations, after receipt of the content file has been confirmed, at this point, each computing device or mobile computing device may display a page of the document of the downloaded content according to the page offset that has been assigned to that computing device.

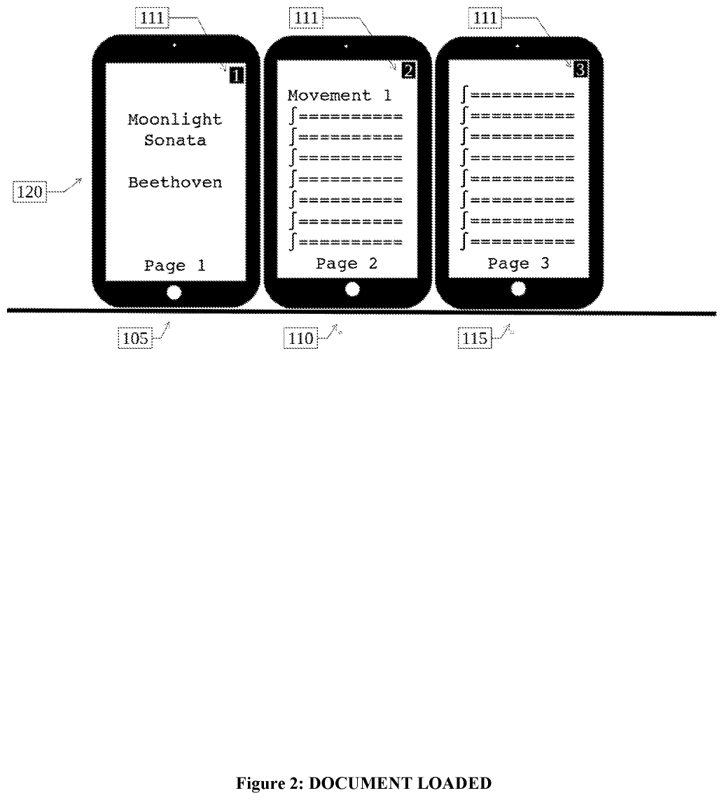

FIG. 2 illustrates three computing devices operating the page turning software application according to some implementations. FIG. 2 illustrates three computing devices or mobile computing devices 105 110 and 115 each having a page offset button 111. In some implementations, each of the three computing devices 105 110 and 115 may also have a display or screen or which presents content to the user or operator. As is illustrated in FIG. 2, the left most computing device 105 has a page offset of 1 and is displaying the first page of the sheet music (e.g., the title page of the sheet music); the center computing device 110 has a page offset 111 of 2 and is displaying the 2^{nd} page of the sheet music on its screen 120 (e.g., the beginning of movement 1); and the right most computing device 115 has a page offset 111 of 3 and is displaying the 3^{rd} page of the sheet music on its screen 120 (e.g., the continuing display of movement 1).

Scrolling through Pages—In some embodiments, scrolling forward may be assumed to be a typical direction of progressing though the music or pages of a loaded document. In some implementations, in order to initiate page scrolling or page progression in the page turning software application, the performer or operator may instruct the page turning software application to turn to a next page for each of the computing devices in the multi-device document viewer by either tapping on a main screen of any of the computing devices or mobile computing devices in the established group, or by scrolling left on a main screen of any of the computing devices or mobile computing devices.

In some implementations, a performer may indicate or instruct the page turning software application to turn to a previous page by scrolling right on any of the computing devices on the main screen of the page-turning software application. In some implementations, the computing device which senses a tap or scroll operation in the page turning software application may send or communicate a message to all computing devices in the group that forms the multi-device document viewer as soon as the tap operation is complete or as the scroll operation has sensed in which direction the scroll is being made. In response to the message being communicated, in some implementations, each computing device may then scroll their associated screen in the page-turning software application to the next page (e.g., in response to a tap or forward-scroll operation) or to the previous page (in response to a reverse-scroll operation). In some implementations, the scrolling may occur using the computing device's built-in animation (if supported).

In some implementations, each computing device may have a “base page” variable which is the same for all computing devices. In some implementations, the “base page” variable may represent a page of the document minus a page offset configured for each computing device. In some implementations, the base page variable may be used in all “page turn” messages that are communicated from an initiating computing device and/or received from other computing devices, so that no other computing device needs to know the page offsets of the other computing devices in the group that forms the multi-device document viewer.

In some implementations, for example, a device “A” with a page offset of 3 displaying page 5 undergoes or receives a forward scroll operation. In response to the forward scroll operation, the computing device “A” may issue a message to the other group devices that the base page of the group is moving from page 2 (displayed page 5−page offset 3) to page 3. In these implementations, another device “B” in the group with a page offset of 2 may receive this message and may move its displayed page from page 4 (base page 2 in message+page offset 2) to page 5. In some implementation, note that since all messages are sent using the base page number change, a sending device does not need to know the page offsets of all other devices in the group.

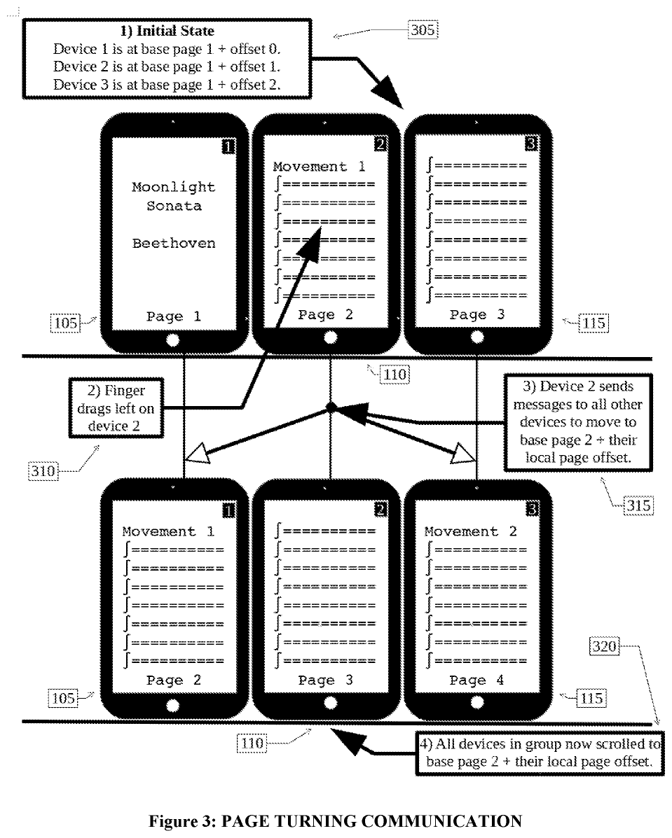

FIG. 3 illustrates a sequence of events when a page is turned in a page turning software application according to some implementations. As illustrated in FIG. 3, an initial state 305 includes device 105 with a base page of 1 and an offset of 0; device 110 is at a base page 1 and offset of 1; and device 115 is at a base page 1 plus offset of 2. In some implementations, the page turning software application may detect an operator or user dragging a finger left 310 on device 110 indicating the scrolling is to drag left on computing device 110. In some implementations, in response to the detection of the finger dragging left on device 110, the page turning software application on computing device 110 may send or communicate messages 315 to all other computing devices (e.g., 105 and 115) in the group to change a base page to 2 and the computing devices local page offset. In some implementations, the messages may only include a change in the base page and may not include the page offset. In some implementations, in response to receiving the message from computing device 110, all of the computing devices 105 110 and 115 in the group scroll 320 to base page 2 and the computing device's local page offset.

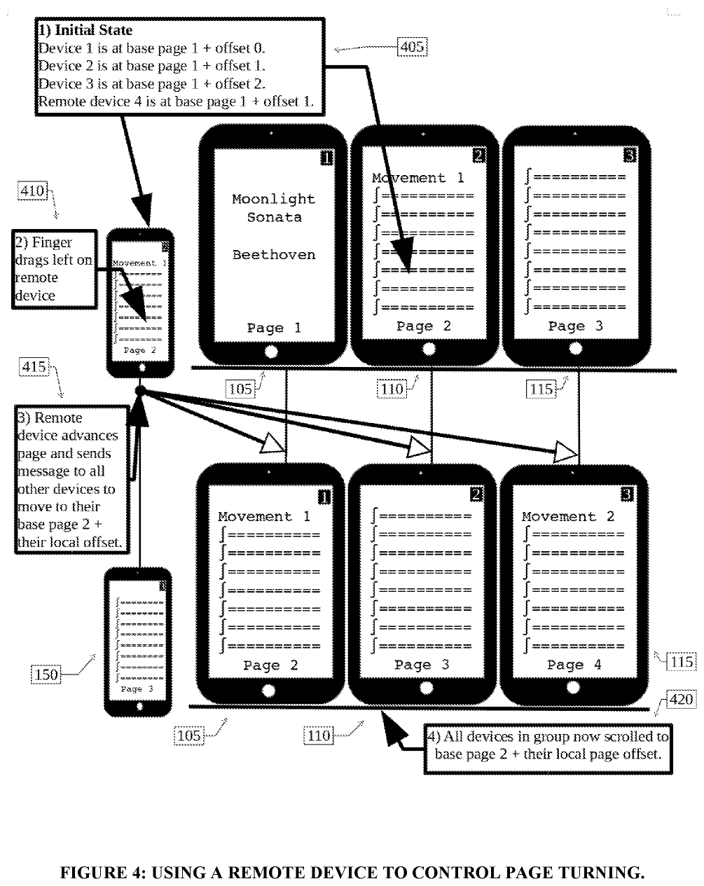

Remote Control—The multi-device document viewer including the page-turning software application may include additional features and/or different configurations. One of these features may be Remote Control from a smartphone (Mobile Communication Device) or Watch (or Other Wearable Computing Device). In some implementations, a remote device (e.g., any remote computing device including mobile communication devices or smart watches, a desktop computing device or another remote electronic device) that is configured to run the page turning software application may allow an assistant of a performer to be a page turner for the multi-device document viewer at a distance away from the performer. In this implementation, this allows the assistant to not be in a physical vicinity of the performer and to not the disturb the performer or lean into a physical space of the performer. In some implementations, the remote (e.g., not the performer's) computing device may be small is size and may utilize a “page offset” setting of 1. FIG. 4 shows a small or remote computing device (e.g., a smartphone or mobile communication device) communicating with and controlling the page turning software application remotely according to some implementations. In some implementations, the small computing device may be an iPhone, an iWatch or other wearable computing device or potentially other wearable electronic devices such as smart glasses or smart clothing. In some implementations, a smart watch (e.g., an Apple Watch) may be used in a less obtrusive manner. In such implementations, the smart watch or other wearable computing devices may be used to connect to the group as an input-only device (e.g., will not display the pages or turn the pages of the document). In embodiments, the smart watch (and the page-turning software application installed thereon) may recognize a tap or a swiping on the smart watch face, and thus the smart watch or other wearable computing device may remotely control the page turning in the page turning software application for the other devices in the designated group of the multi-device document viewer. As illustrated in FIG. 4, an initial state 405 includes device 105 with a base page of 1 and an offset of 0; device 110 is at base page 1 and offset of 1; and device 115 is at base page 1 plus offset of 2. In some implementations, the page turning software application may detect an operator or user dragging a finger left 410 on remote computing or electronic device 150 indicating the scrolling is to drag left on remote computing device 150. In some implementations, in response to the detection of the finger dragging left on device 150, the page turning software application on computing device 150 may advance the page and/or may send or communicate messages 415 to all other computing devices (e.g., 105, 110 and 115) in the group to change a base page to 2 and the computing device's local page offset. In some implementations, in response to receiving the message from computing device 150, all of the computing devices 105 110 and 115 in the group scroll 420 to base page 2 and the computing device's local page offset. In some implementations, a conductor of an orchestra may actually control multiple or a plurality of multi-device document viewers in unison or in a synchronous fashion. In some implementations, for example, a conductor may have a computing device running page turning software and may be able to control the plurality of multi-device document viewers that each performer in the orchestra may be using. In some implementations, the computing device may be incorporated into a wand or conducting device so that the conductor can wave the wand or computing device a certain direction that the conductor believes the pages should be turned.

Synchronized Brightness Slider—In some implementations, the page turning software application may also provide a brightness slider or icon on a screen or display of a computing device. In some embodiments, a brightness slider displayed on a screen of the page turning software application may allow a user or operator to adjust brightness of all the computing device screens (or mobile computing device screens) in a group of the multi-device document viewer in unison (e.g., simultaneously or in a synchronized fashion). In some implementations, any change in a slider position on any of the computing devices, may cause a message to be generated by the computing device that received the change in slider position and then communicated to the other computing devices in the group. In some implementations, in response to the received message, the other computing device may adjust their brightness accordingly. In some implementations, this allows the performer to adjust a brightness of the group of computing devices as a whole from a single control on a single computing device or mobile computing device.

Integration with a Foot Button—In some implementations, a foot button may be utilized as an input-only device to turn all pages of a document for the group of computing devices in the multi-device document viewer in unison. In some implementations, this extends the use of the foot button turning solution by utilizing a single press of the foot button. In some implementations, the foot button may need to be connected either through a cable or through some wireless communication method in order for the pressing of the foot button to initiate the page turning software application to the computing devices in the designated group of devices in the multi-device document viewer.

Accelerometer-Based Position Setup. In some implementations, one or more computing devices (or mobile computing devices) may include one or more accelerometers. In some implementations, the accelerometer installed in the computing devise may detect small relative movements of the computing device or the mobile computing device by capturing acceleration movements in one direction or the other. In other words, relative positions may be determined based at least in part on the captured acceleration movements. In some implementations, the page turning software application may synchronize the page offsets for the computing devices in the groups of the multi-device document viewer by aligning them together in a stack, pressing a button on the top computing device, and then moving the computing devices into a final position for display. In some implementations, the accelerometers may detect an initial position of the computing devices and then a subsequent position of the computing devices (both initially and after movement). In some implementations, the page turning software application may then calculate the page offsets from the different acceleration readings or measurements received from the one or more accelerometers in each of the computing devices in the multi-device document viewer. In some implementations, for example, the top computing device in the stack may have an offset of 0; the second computing device in the stack may have an offset of 1; and the third computing device in the stack may have an offset of 2.

Vertical and Diagonal Scrolling—In some implementations, in addition to advancing pages across computing devices or mobile communication devices arranged horizontally, the claimed subject matter and disclosure is extensible and/or also applies to scrolling pages up and down across a group of devices arranged in a vertical pattern and/or even in a diagonal pattern. In some implementations, the claimed subject matter and disclosure may be taken further by considering a “matrix” of devices, each with both a horizontal and vertical page offset. When the screen on one device swipes left, all devices advance to their next horizontal page. When the screen on one device swipes down, all devices advance to their next vertical page. When the screen on one device swipes in a left-down direction, all devices advance to their next vertical page and horizontal page. In some implementations, this may allow a huge display screen (e.g., matrix of display screens to display a large document or a series of images to users and to easily maintained). In some implementations, a remote computing device may also be utilized to control operation of the vertical and/or diagonal scrolling.

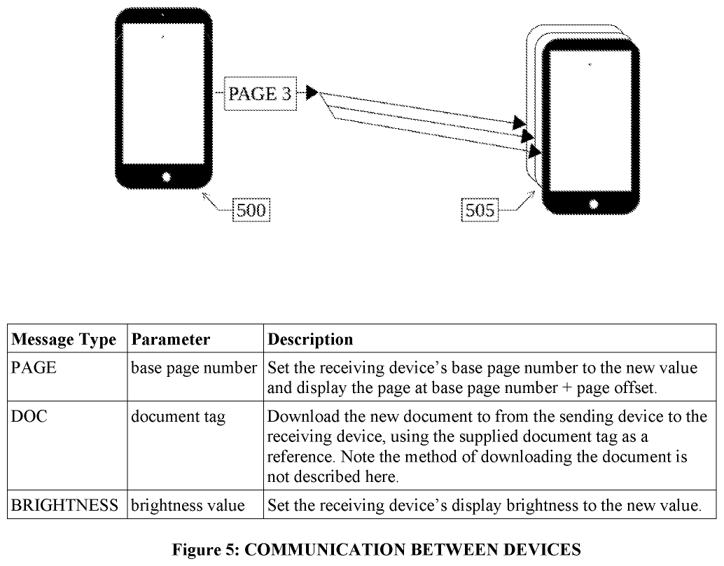

Communications Between Devices—FIG. 5 illustrates communications between a computing device (e.g., an initiating computing device) and the rest of computing devices of the group of the multi-device document viewer utilizing a multicast message according to some implementations. In a multicast message, all of the other computing devices in the group of the multi-device document viewer may receive the message from the initiating computing device at the same time or approximately the same time (e.g., the message is transmitted to the receiving devices at the same time). In some implementations, where multicast messaging is not available, such as with certain communication protocols, (e.g., such as the Bluetooth communication protocol), each message may be replicated and the separate messages may be communicated to the other computing devices in the multi-device document viewer (e.g., via a unicast message) in a sequential fashion.

In some implementations, the page turning software application may utilize and/or generate a number of different types of messages. In some implementations, a page message type may have a parameter of a base page number or representative of a base page number. In some implementations, the page message type in the page turning software application may set a receiving device's base page number to a parameter value (e.g., the received new page number) and the receiving computing device may display the page of a base page number plus page offset.

In some implementations, the document or doc message type may have a parameter of a document tag. In some implementations, the document message type in the page turning software application may download a new document from the sending device to the receiving device using the supplied document tag as a reference and/or location.

In some implementations, the document or doc message type may have a parameter of a document tag. In some implementations, receipt of the document message type in the page turning software application by the receiving device may initiate the download a new document from the sending device or other location to the receiving device using the supplied document tag as a reference and/or location.

In some implementations, a brightness message type may have a parameter of a brightness value. In some implementations, the brightness message type in the page turning software application may set the receiving devices' brightness display to a new or the received value.

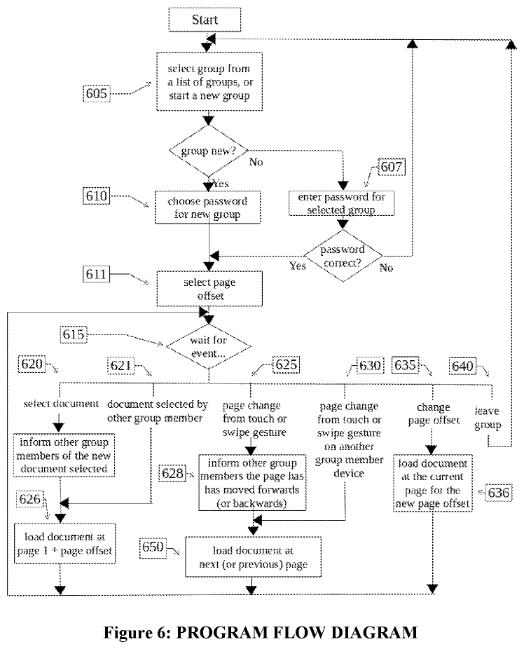

FIG. 6 illustrates a process flow diagram of the page-turning software application according to some implementations.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

In some implementations, in step 605, a page-turning software application may allow a user to select a group from a list of groups of computing devices or to start or establish a new group of computing devices for a multi-device document viewer. In some implementations, if the operator selects an existing group, in step 607, the page-turning software application may allow a user to enter a password in order to be allowed to enter the new group. In some implementations, in step 610, the page-turning software application may allow a user or operator to establish a new group as well as a password for the group of computing devices or mobile computing device that make up the multi-device document viewer. In some embodiments, in step 611, the page-turning software application may allow an operator to set an offset parameter for a computing device in the multi-device document viewer.

In some implementations, in step 620, a page-turning software application may receive a select document event. In some implementations, a page-turning software application on the computing device or mobile computing device receiving the select document command or event, may communicate or inform other group members (e.g., group computing devices) in the multi-device document viewer the document that is or has been selected and/or downloaded from another computing device. In some implementations, in step 621, the page-turning software application on the computing device that did not receive the document select command or event at the computing device, will receive the message as to which document is selected. In some implementations, in response to the selected document command or event, in step 626, the page-turning software application (at each of the computing devices in the group of computing devices of the multi-device document viewer) may load the selected document at page 1 (plus the respective computing devices' page offset).

In some implementations, in step 625, the page-turning software application at one of the computing devices in the group, may receive or detect a page change instruction or command from a touch or swipe gesture on one of the computing devices or mobile computing devices in the group of computing devices that form the multi-device document viewer. In response to the detection of the page change instruction at a selected computing device, in step 628, the selected computing device may inform or communicate to other group member computing devices that the page is to be moved forward or backward (depending on the received touch or swipe gesture). In some implementations, in step 630, another computing device may receive the page change and then the one computing device receives the message from the other computing device that the page change from a touch or swipe gesture has been received (e.g., verification from the other computing devices in the multi-device document viewer). In some implementations, in step 650, the page-turning software application may load the document being displayed at the next (or previous) page (depending on the direction of the touch or swipe gesture).

In some implementations, in step 635, the page-turning software application at one of the computing devices may receive a change offset event or command. In response to the change offset event or command, in some implementations, in step 636, the page-turning software application may load the document at the current page with the new page offset to the respective computing devices of the multi-device document viewer.

In some implementations, in step 640, the page-turning software application at one of the computing devices may receive a leave group command from one or more of the computing devices in the multi-device document viewer. In response, the page-turning software application may reset or reinitiate because a smaller number of computing devices are being utilized in the multi-device document viewer and/or maybe the multi-device document viewer may not be utilized.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A method of operating a multi-device document viewer, comprising:
receiving a selection of two or more computing devices to be included in a selected group of computing devices that create the multi-device document viewer;
assigning the two or more computing devices to the selected group;
assigning a page offset value for each of the two or more computing devices in the selected group, the page offset value identifying an offset from a base page for each of the two or more computing devices;
receiving a selection of a document to be viewed on the multi-device document viewer at one computing device of the two or more computing devices; and
displaying pages of the selected document on the two or more computing devices corresponding based on the assigned page offset value for each of the two or more computing devices.

2. The method of claim 1, further comprising:
receiving a password for the selected group of computing devices; and
allowing access to the selected group of computing devices if the password matches the group password.

3. The method of claim 1, wherein the selection of the document is received at a master computing device, and further comprising communicating the selected document to remaining computing devices of the computing devices that are not the master computing device.

4. The method of claim 1, wherein the selected of the document is not received at a master computing device, and further comprising:
communicating a message to the master computing device identifying which document is selected; and
communicating the selected document to remaining computing devices of the selected group of computing devices besides the master computing device.

5. The method of claim 1, further comprising receiving a page change selection from one of the one or more computing devices to change pages that are to be displayed on the two or more computing devices.

6. The method of claim 5, further comprising communicating a message to other computing devices of the one or more computing devices besides the one computing device that received the page change selection identifying that the page change selection has been received.

7. The method of claim 6, further comprising loading a page of the selected document corresponding to the base page plus the page offset value for each of the associated computing devices.

8. The method of claim 1, further comprising receiving a change page offset request from an individual computing device and communicating the change page offset request to other computing devices besides the individual computing device.

9. The method of claim 1, further comprising receiving a change base page request from an individual computing device and communicating the change base page request to other computing devices besides the individual computing device.

10. The method of claim 1, further comprising:
receiving a leave group message from one computing device;
communicating the leave group message to the other computing devices in the group; and
removing the one computing device from group of computing devices that formed the multi-device document viewer.

11. The method of claim 1, further comprising a remote computing device, the remote computing device to control operations of the group of computing devices that form the multi-device document viewer.

12. The method of claim 1, further comprising receiving a brightness value change request at one computing device of the group of computing devices;
communicating the brightness value change request to other computing devices in the group of computing devices besides the one computing device; and
changing a brightness level in displays or monitors of the group of computing device in response to the brightness value change request.

13. The method of claim 1, further comprising a foot pedal, the foot pedal communicatively coupled with one or more computing devices of the group of computing devices, the foot pedal to communicate a page turning request to the group of computing devices to cause the group of computing devices to simultaneously change the displayed pages in each of the group of computing devices that form the multi-device document viewer.

14. The method of claim 1, further comprising two or more accelerometers, at least one accelerometer assigned to each respective computing device, the two or more accelerometers to capture acceleration measurements of each of the two or more computing devices in the group of computing devices, and to determine positions of the two or more computing devices relative to each other based at least in part on the captured acceleration measurements.

15. The method of claim 14, further comprising aligning the two or more computing devices together in a stack, pressing a button on the top computing device, and then moving the two or more computing devices into a final position for display.

16. The method of claim 15, further comprising calculating the page offsets from the different captured acceleration measurements received from the two or more accelerometers subsequent to pressing the button on the top computing device.

17. The method of claim 1, further comprising receiving an indicator or messages that a page offset button or icon at a first computing device has been pressed for longer than a predetermined time; and
entering an easy page offset mode at the first computing device.

18. The method of claim 17, further comprising communicating to all other computing devices of the two or more computing devices in the group that an easy page offset mode has been initiated.

19. The method of claim 18, further comprising tapping each of the computing devices in an order that corresponds to the page offset for the page offset for each of the computing devices and setting the page offset value according to the tapping order.
